(19) United States
(12) Patent Application Publication
(10) Pub. No.: US 2016/0117825 A1
(43) Pub. Date: Apr. 28, 2016

(54) INFORMATION PROCESSING APPARATUS, INFORMATION PROCESSING SYSTEM, AND ALLOCATION INFORMATION GENERATION METHOD

(71) Applicant: Noriaki HAMADA, Kanagawa (JP)

(72) Inventor: Noriaki HAMADA, Kanagawa (JP)

(21) Appl. No.: 14/919,023

(22) Filed: Oct. 21, 2015

(30) Foreign Application Priority Data
Oct. 22, 2014 (JP) 2014-215706

(51) Int. Cl. G06T 7/00; H04N 5/232; G06K 9/00; G06F 3/0481

(52) U.S. Cl. CPC G06T 7/0042; G06F 3/04817; H04N 5/23229; G06K 9/00771; G06T 2207/10004

(57) ABSTRACT

An information processing apparatus includes a measurement information acquisition unit, an image acquisition unit, an image recognition unit, and a generation unit. The measurement information acquisition unit acquires measurement information obtained by measuring a space in which at least one device and at least one object are allocated. The image acquisition unit acquires an image obtained by imaging the space. The image recognition unit recognizes the at least one device from the image. On the basis of the measurement information and a result of the recognition of the at least one device, the generation unit generates allocation information that represents allocation of the at least one device and the at least one object in the space and that enables identification of the at least one device.

### CROSS-REFERENCE TO RELATED APPLICATIONS

The present application claims priority to and incorporates by reference the entire contents of Japanese Patent Application No. 2014-215706 filed in Japan on Oct. 22, 2014.

### BACKGROUND OF THE INVENTION

1. Field of the Invention

The present invention relates to an information processing apparatus, an information processing system, and an allocation information generation method.

2. Description of the Related Art

A technology has been known for generating allocation information representing allocation of at least one device and at least one object at a floor of, for example, an office, by adding an icon representing a device allocated at the floor, such as desks at the floor, at the position at which the device is allocated at the floor (see Japanese Patent No. 4909674).

The conventional technology, however, has a problem in that, because a user actually recognizes the position of a device allocated at a floor and generates allocation information by manually adding an icon of the device at the position of the device on the allocation represented by intermediate allocation information, it takes time to generate allocation information.

### BRIEF DESCRIPTION OF THE DRAWINGS

FIG. 1 is a block diagram illustrating an exemplary configuration of an information processing system according to an embodiment;

FIG. 2 is an explanatory view of exemplary measurement performed by a measurement device according to the embodiment;

FIG. 3 is a block diagram illustrating an exemplary hardware configuration of a device according to the embodiment;

FIG. 4 is a block diagram illustrating an exemplary functional configuration of the device according to the embodiment;

FIG. 5 is a block diagram illustrating an exemplary hardware configuration of an information processing apparatus according to the embodiment;

FIG. 6 is a block diagram illustrating an exemplary functional configuration of an information processing apparatus according to the embodiment;

FIG. 7 is a diagram illustrating an example of shape information according to the embodiment;

FIG. 8 is a diagram illustrating an example of an allocation represented by intermediate allocation information according to the embodiment;

FIG. 9 is a diagram illustrating an example of device information stored in a device information storage unit according to the embodiment;

FIG. 10 is a diagram illustrating an example of device allocation information according to the embodiment;

FIG. 11 is a diagram illustrating an example of an allocation image according to the embodiment;

FIG. 12 is a flowchart illustrating an exemplary process executed by the information processing apparatus according to the embodiment; and

FIG. 13 is a diagram illustrating an example of an allocation image according to a second modification.

### DETAILED DESCRIPTION OF THE PREFERRED EMBODIMENTS

An embodiment will be described in detail below with reference to the accompanying drawings.

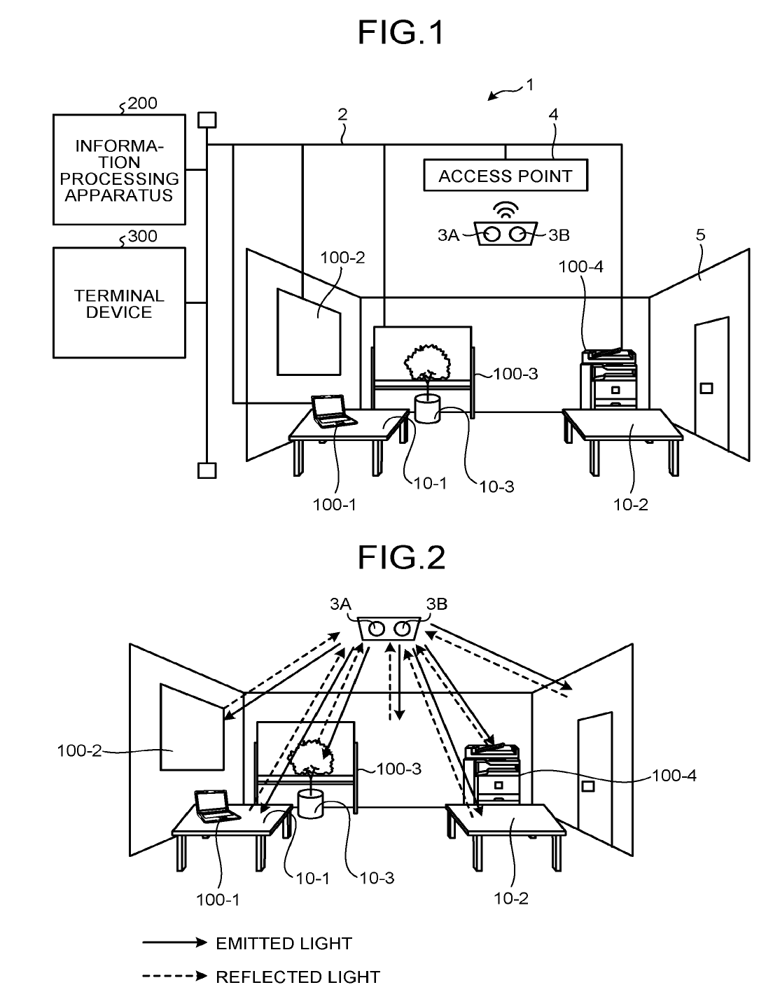

FIG. 1 is a block diagram illustrating an exemplary configuration of an information processing system 1 according to the embodiment. As illustrated in FIG. 1, the information processing system 1 includes a measurement device 3A, an imaging device 3B, an access point 4, devices 100-1 to 100-4, an information processing apparatus 200, and a terminal device 300 (that is an example of an external device).

According to the embodiment, the measurement device 3A, the imaging device 3B, the access point 4, and the devices 100-1 to 100-4 are provided at a floor 5 (an example of a space space) of, for example, an office, and the information processing apparatus 200 and the terminal device 300 are provided at a location different from the floor 5. At the floor 5, objects 10-1 to 10-3 are allocated as well.

In other words, the devices 100-1 to 100-4 and the objects 10-1 to 10-3 are allocated at the floor 5. According to the embodiment, the floor of the office is exemplified as an example of a space. However, the space is not limited to this. Alternatively, the space may be a rental office or an event site, for example.

According to the embodiment, the device 100-1 is a laptop personal computer (PC), the device 100-2 is a display, the device 100-3 is an electronic black board, and the device 100-4 is a multifunction peripheral; however, devices are not limited to them. As devices, for example, there are image forming devices, such as a printing device, a copy machine, a multifunction peripheral, a scanner device, and a facsimile machine; various electronic devices, such as a projector, a camera, an air conditioner, a refrigerator, a fluorescent lighting, a vending machine, and a hand-held terminal; a PC; a smartphone; and a tablet terminal. The multifunction peripheral has at least two of a copying function, a printing function, a scanner function, and a facsimile function.

According to the embodiment, the objects 10-1 and 10-2 are desks and the object 10-3 is a plant; however, objects are not limited to them. It suffices if the objects be non-moving objects other than the devices allocated at the floor 5. A shelf and a locker are other examples.

In the following descriptions, the devices 100-1 to 100-4 may be simply referred to as devices 100 when it is not necessary to distinguish them from one another and the objects 10-1 to 10-3 may be simply referred to objects 10 when it is not necessary to distinguish them from one another.

The access point 4, the devices 100-1 to 100-4, the information processing apparatus 200, and the terminal device 300 are connected via a network 2. It is possible to implement the network 2 by using, for example, the Internet or a local area network (LAN).

The measurement device 3A measures the floor 5 and obtains measurement information that is the result of the measurement. As the measurement device 3A, for example, there is a laser sensor that measures the distance to an subject and the shape of the subject by using the time of flight (TOF) system. In this case, as illustrated in FIG. 2, the measurement device 3A emits laser light and detects the reflected light of the laser light and, from the time after the emission of the laser light until the detection of the reflected light, measures the distance to the subject (such as a wall of the floor 5, the device 100, or the object 10) positioned in the direction in which the laser light is emitted and its shape. The measurement device 3A repeats the above-described operation until measurement with respect to all directions is performed and generates, as measurement information, a measurement image representing the distances (depths) from the measurement device 3A to the wall of the floor 5, the device 100, and the object 10 and their shapes.

The imaging device 3B captures an image of the floor 5. The imaging device 3B has to image all the devices 100-1 to 100-4 allocated at the floor 5. With respect to such conditions for imaging, it is preferable to use, as the imaging device 3B, an omnidirectional camera capable of capturing a sphere image of all directions (360°) about the imaging device 3B. However, the imaging device is not limited to this. Alternatively, for example, a digital camera that is allocated to image all the devices 100-1 to 100-4 allocated at the floor 5 may be used.

According to the embodiment, it is assumed that the measurement device 3A and the imaging device 3B are housed in a casing and calibration is previously performed. For this reason, from positions on the image captured by the imaging device 3B, it is possible to determine positions on measurement information (a measurement image), which correspond to the positions on the image, of the measurement device 3A.

The access point 4 is a radio device for connecting the measurement device 3A and the imaging device 3B wirelessly to the network 2.

The information processing apparatus 200 shows allocation of at least one device 100 and at least one object 10 at the floor 5 and generates allocation information that enables identification of the at least one device 100. For example, the information processing apparatus 200 may be a computer. The information processing apparatus 200 may be implemented as two or more computers, i.e., as a system.

The terminal device 300 is a terminal that accesses the information processing apparatus 200. For example, the terminal device 300 may be a PC, a smartphone, or a tablet terminal.

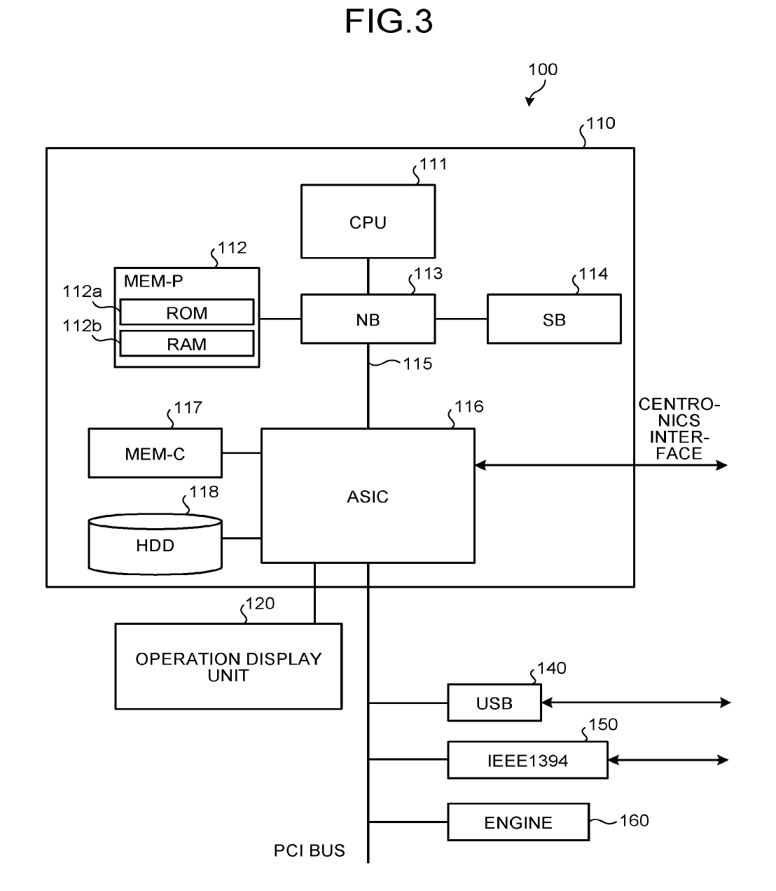

FIG. 3 is a block diagram illustrating an exemplary hardware configuration of the device 100 according to the embodiment. The block diagram of the hardware configuration illustrated in FIG. 3 exemplifies a block diagram of a hardware configuration of the device 100-4, i.e., an image forming device, such as a multifunction peripheral, and the hardware configurations of all the devices 100 are not limited to this.

As illustrated in FIG. 3, the device 100 has a configuration in which a controller 110 and an engine unit 160 are connected via a PCI bus. The controller 110 is a controller that comprehensively controls the devices 100, drawing, communications, and inputs from an operation display unit 120. The engine unit 160 is an engine connectable to the PCI bus, and the engine unit 160 is, for example, a printer engine of a black-white plotter, one-drum color plotter or a four-drum color plotter, or a scanner engine of a scanner, or the like. The engine unit 160 includes, in addition to the engine part, an image processing part of, for example, error diffusion and gamma conversion.

The controller 110 includes a CPU 111, a north bridge (NB) 113, a system memory (MEM-P) 112, a south bridge (SB) 114, a local memory (MEM-C) 117, an application specific integrated circuit (ASIC) 116, and a hard disk drive (HDD) 118, and the controller 110 has a configuration in which the NB 113 and the ASIC 116 are connected via an accelerated graphics port (AGP) bus 115. The MEM-P112 further includes a ROM 112a and a RAM 112b.

The CPU 111 comprehensively controls the devices 100. The CPU 111 includes a chip set consisting of the NB 113, the MEM-P 112, and the SB 114 and is connected to other devices via the chip set.

The NB 113 is a bridge for connecting the CPU 111 to the MEM-P 112, the SB 114, and the AGP bus 115. The NB 113 includes a memory controller for controlling read/write with respect to the MEM-P 112, a PCI master, and an AGP target.

The MEM-P 112 is a system memory that is used as, for example, a memory for storing programs and data, a memory for loading programs and data, and a memory for drawing by a printer. The MEM-P 112 is configured of the ROM 112a and the RAM 112b. The ROM 112a is a memory dedicated to reading that is used as a memory for storing programs and data, and the RAM 112b is a writable and readable memory that is used as a memory for loading programs and data and a drawing memory of a printer.

The SB 114 is a bridge for connecting the NB 113 to a PCI device and peripheral devices. The SB 114 is connected to the NB 113 via the PCI bus to which a network interface (I/F), etc., is connected.

The ASIC 116 is an integrated circuit (IC) that is used for image processing and that includes hardware components for image processing. The ASIC 116 serves as a bridge that connects the AGP bus 115, the PCI bus, the HDD 118, and the MEM-C 117 to one another. The ASIC 116 is configured of a PCI target, an AGP master, an arbiter (ARB) serving as the core of the ASIC 116, a memory controller that controls the MEM-C 117, multiple direct memory access controllers (DMAC) that, for example, rotates image data by using a hardware logic, and a PCI unit that performs data transfer via the PCI bus between the PCI unit and the engine unit 160. An USB 140, and the institute of electrical and electronics engineers 1394 (IEEE 1394) interface (I/F) 150 is connected to the ASIC 116. The operation display unit 120 is directly connected to the ASIC 116.

The MEM-C 117 is a local memory that is used as an image buffer for copy and coding buffer, and the HDD 118 is a storage for accumulating image data, accumulating programs, accumulating font data, and accumulating forms.

The AGP bus 115 is a bus interface for a graphics accelerator card that is proposed to accelerate graphic processing. By directly accessing the MEM-P 112, the AGP bus 115 accelerates the graphics accelerator card.

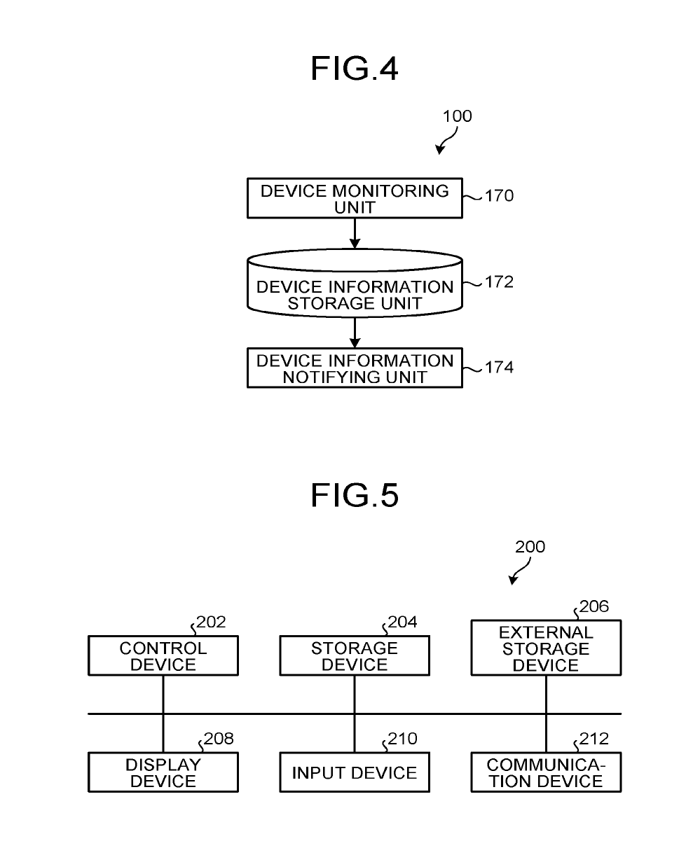

FIG. 4 is a block diagram illustrating an exemplary functional configuration of the device 100 according to the embodiment. As illustrated in FIG. 4, the device 100 includes a device monitoring unit 170, a device information storage unit 172, and a device information notifying unit 174.

The device monitoring unit 170 and the device information notifying unit 174 are implemented by using, for example, the CPU 111 and the MEM-P 112, and the device information storage unit 172 is implemented by using, for example, at least any one of the HDD 118 and the MEM-P 112.

The device monitoring unit 170 monitors the devices 100, generates device information on the devices 100, and stores the device information in the device information storage unit 172. According to the embodiment, the device information contains device identifying information that identifies the devices 100, the type identifying information that identifies the types of the devices 100, and state information representing the states of the device 100; however, information contained in the device information is not limited to them.

Examples of the device identifying information include, for example, an ID, a serial number, a MAC address, and an IP address. Examples of the type identifying information include, for example, a model name. The state may be a normal state or a failure state, for example.

The device information notifying unit 174 notifies the information processing apparatus 200 of the device information that is generated by the device monitoring unit 170. According to the embodiment, the device information notifying unit 174 acquires the device information from the device information storage unit 172 once a day and notifies the information processing apparatus 200 of the device information; however, the device information notifying unit is not limited to this.

According to the embodiment, the devices 100 have code information obtained by coding the device identifying information on the devices 100.

FIG. 5 is a block diagram illustrating an exemplary hardware configuration of the information processing apparatus 200 according to the embodiment. The information processing apparatus 200 includes a control device 202, such as a CPU or a graphic processing unit (GPU), a storage device 204, such as a ROM or a RAM, an external storage device 206, such as an HDD or a solid state drive (SSD), a display device 208, such as a display, an input device 210, such as a keyboard and a mouse, and a communication device 212, such as a communication interface, i.e., the information processing apparatus 200 has a hardware configuration using a general computer.

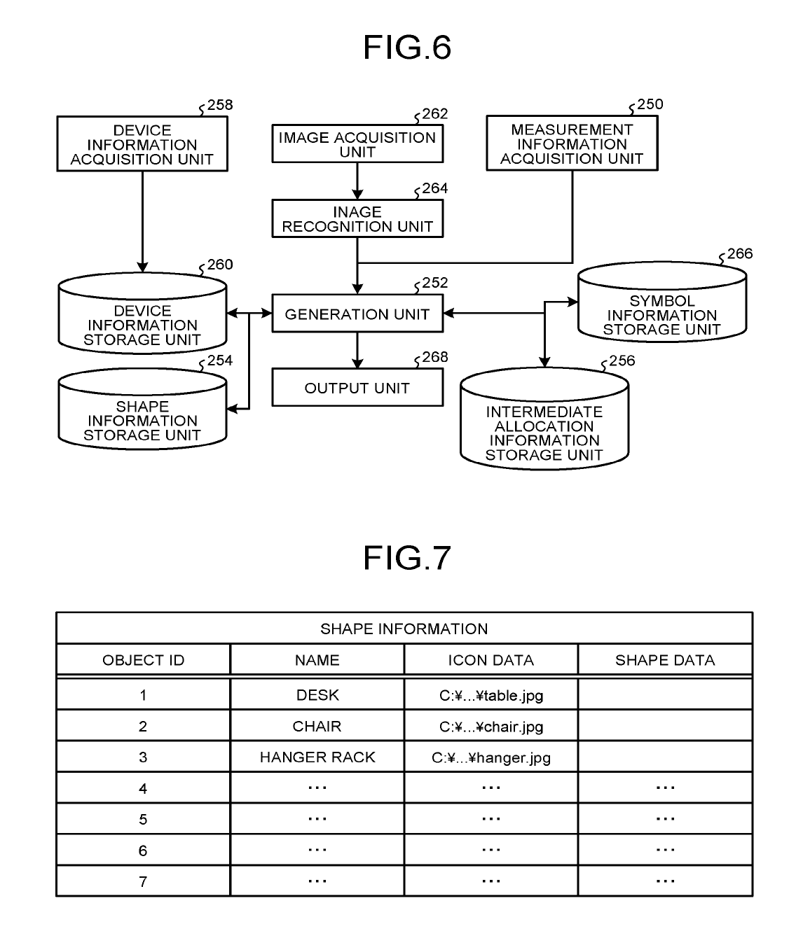

FIG. 6 is a block diagram illustrating an exemplary functional configuration of the information processing apparatus 200 according to the embodiment. For example, the control device 202 executes a program stored in the external storage device 206 so that the functional configuration is configured in the storage device 204. As illustrated in FIG. 6, the information processing apparatus 200 includes a measurement information acquisition unit 250, a generation unit 252, a shape information storage unit 254, an intermediate allocation information storage unit 256, a device information acquisition unit 258, a device information storage unit 260, an image acquisition unit 262, an image recognition unit 264, a symbol information storage unit 266, and an output unit 268.

The measurement information acquisition unit 250, the generation unit 252, the device information acquisition unit 258, the image acquisition unit 262, the image recognition unit 264, and the output unit 268 are implemented by using, for example, the control device 202 and the storage device 204, and the shape information storage unit 254, the intermediate allocation information storage unit 256, the device information storage unit 260, and the symbol information storage unit 266 are implemented by using, for example, at least any one of the storage device 204 and the external storage device 206.

The measurement information acquisition unit 250 acquires measurement information from the measurement device 3A.

On the basis of the measurement information acquired by the measurement information acquisition unit 250, the generation unit 252 generates intermediate allocation information representing allocation of at least one object 10 at the floor 5. Specifically, the generation unit 252 acquires shape information representing the shape of at least one object 10 from the shape information storage unit 254, generates intermediate allocation information on the basis of the acquired shape information and the acquired measurement information, and stores the intermediate allocation information in the intermediate allocation information storage unit 256.

FIG. 7 is a diagram illustrating an example of shape information according to the embodiment. According to the example illustrated in FIG. 7, the shape information is information in which the object ID of an object, the name of the object, icon data representing the icon of the object, and shape data representing the shape of the object are associated one another. Note that specific values of the shape data are not illustrated in FIG. 7. While the distance to the object and its shape are specified in the measurement information acquired by the measurement information acquisition unit 250, which object 10 is the subject is not specified. For this reason, by using the shape information, the generation unit 252 collates the shape specified in the measurement information, and determines which object 10 has that shape, thereby generating intermediate allocation information.

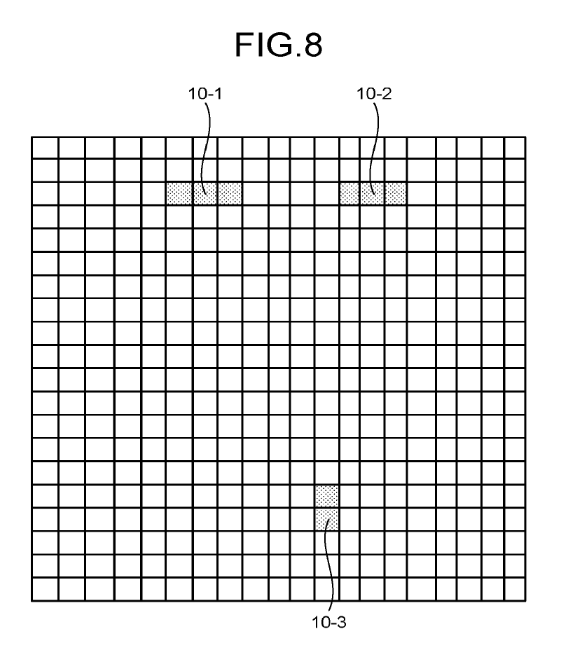

FIG. 8 is a diagram illustrating an example of allocation represented by the intermediate allocation information according to the embodiment. According to the embodiment, because the measurement device 3A is set on the ceiling of the floor 5, according to the example illustrated in FIG. 8, the intermediate allocation information represents allocation of the objects 10-1 to 10-3 on the plane view of the floor 5. Practically, icons of desks are allocated at the positions of the objects 10-1 and 10-2 and an icon of a plant is allocated at the position of the object 10-3.

The device information acquisition unit 258 acquires device information on each of the at least one device 100 from each of the at least one device 100 and stores the device information in the device information storage unit 260. Practically, the device information acquisition unit 258 acquires device information from devices not illustrated in FIG. 10 other than the devices 100.

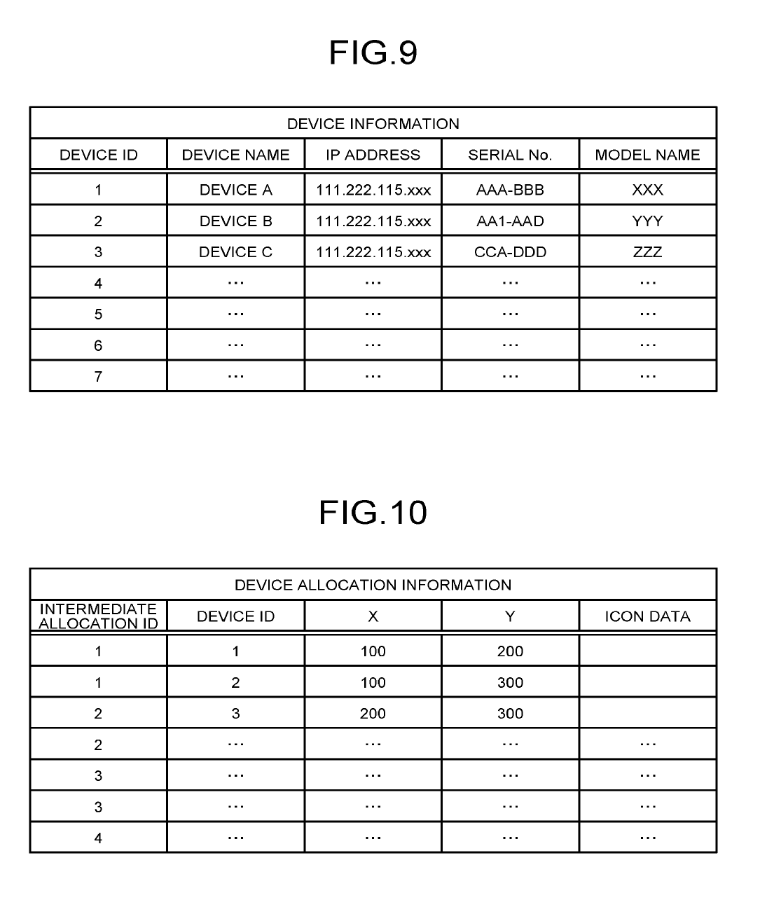

FIG. 9 is a diagram illustrating an example of device information stored in the device information storage unit 260 according to the embodiment. According to the example illustrated in FIG. 9, the device information is information in which the device ID of a device, the device name of the device, the IP address of the device, the serial number (No) of the device, and the model name of the device are associated to one another.

The image acquisition unit 262 acquires an image from the imaging device 3B.

The image recognition unit 264 recognizes at least one device 100 from the image acquired by the image acquisition unit 262. As described above, according to the embodiment, the devices 100 have code information obtained by coding the device identifying information on the devices 100. For this reason, the image recognition unit 264 extracts at least one piece of code information from the image acquired by the image acquisition unit 262 and recognizes the at least one device 100 by, on the basis of the at least one piece of code information, identifying the at least one device 100 and determining the position of the at least one device 100 on the image. It is possible to identify the device 100 from the device identifying information obtained by decoding the extracted code information and it is possible to determine the position of the device 100 on the image from the coordinates of the position on the image from which the code information is extracted.

Here, the generation unit 252 is described again.

On the basis of the measurement information acquired by the measurement information acquisition unit 250 and the result of recognition of the at least one device performed by the image recognition unit 264, the generation unit 252 generate allocation information that represents the allocation of the at least one device 100 and at least one object 10 at the floor 5 and that enables identification of the at least one device 100.

Specifically, the generation unit 252 acquires intermediate allocation information from the intermediate allocation information storage unit 256, determines the position of the at least one device 100 on the allocation represented by the intermediate allocation information on the basis of the result of the recognition of the at least one device, and generates allocation information as follows. For each of the at least one device 100, the generation unit 252 adds the position information representing the position of the device 100 on the allocation represented by the intermediate allocation information, the device identifying information that identifies the device 100, and symbol information corresponding to the device 100 to the intermediate allocation information. The position information, the device identifying information, and the symbol information that are added to the intermediate allocation information are collectively referred to as device allocation information.

FIG. 10 is a diagram illustrating an example of device allocation information according to the embodiment. According to the example illustrated in FIG. 10, the device allocation information is information in which the intermediate allocation ID in the intermediate allocation information, the device ID that is the device identifying information on the device, the x coordinate and the y coordinate that are the position information on the device, and icon data that is symbol information on the device are associated with one another.

On the basis of the result of calibration on the measurement device 3A and the imaging device 3B and the position of the at least one device on the image recognized by the image recognition unit 264, the generation unit 252 determines the position of the at least one device on the allocation represented by the intermediate allocation information. Specifically, the generation unit 252 determines the position of the at least one device on the allocation represented by the intermediate allocation information by converting the position of the at least one device on the image recognized by the image recognition unit 264 into the position of the at least one device on the allocation represented by the intermediate allocation information by using the result of calibration on the measurement device 3A and the imaging device 3B.

According to the embodiment, for each device 100, the generation unit 252 adds the device information as the device identifying information to the intermediate allocation information. In other words, for each device 100, by using the device identifying information on the device 100 recognized by the image recognition unit 264, the generation unit 252 acquires the device information on the device 100 from the device information storage unit 260 and adds the device information (the device ID in the case illustrated in FIG. 10) to the intermediate allocation information.

According to the embodiment, for each device 100, the generation unit 252 acquires symbol information corresponding to the type identifying information from the symbol information storage unit 266 and adds the symbol information to the intermediate allocation information. Specifically, because, for each device 100, the generation unit 252 acquires the device information from the device information storage unit 260 and the symbol information storage unit 266 stores the type identifying information and the symbol information in association with each other, the generation unit 252 acquires the symbol information corresponding to the type identifying information contained in the device information and adds the symbol information to the intermediate allocation information.

According to the embodiment, the generation unit 252 generates actual distance information on the actual distance of the floor 5 on the basis of the measurement information acquired by the measurement information acquisition unit 250 and adds the actual distance information to the intermediate allocation information. The actual distance information is information representing an actual size in the floor 5. Because the distance (to, for example, the wall of the floor 5, the device 100, or the object 10) is specified in the measurement information, it is possible to determine an actual size in the floor 5 from the measurement information.

The output unit 268 outputs an allocation image based on the allocation information generated by the generation unit 252. According to the embodiment, the output unit 268 outputs the allocation image to the terminal device 300.

The terminal device 300 displays the allocation image output from the output unit 268 on the display device, such as a display (not illustrated).

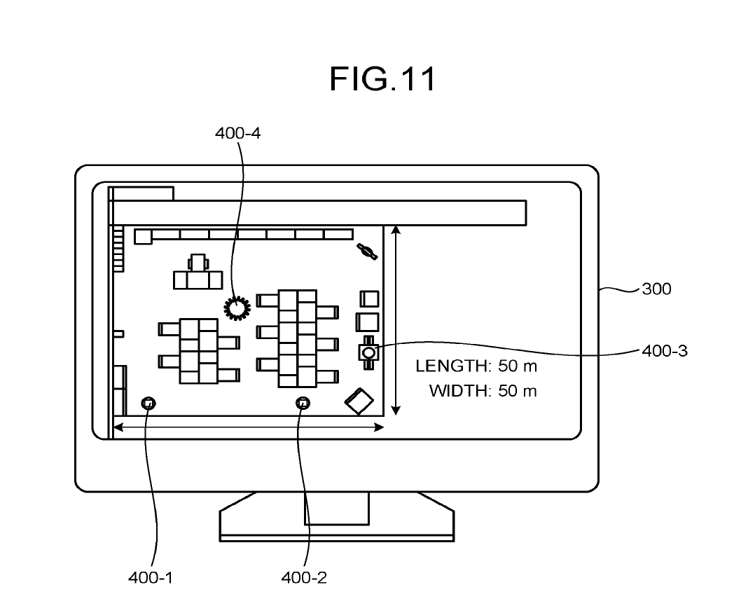

FIG. 11 is a diagram illustrating an example of an allocation image according to the embodiment. According to the example illustrated in FIG. 11, the allocation image is displayed on the display device of the terminal device 300. On the allocation image, icons 400-1 to 400-4 that are symbol information on the device 100 are allocated respectively at the positions of four devices 100 on the allocation represented by the intermediate allocation information and the actual size (the width of 50 m and the length of 50 m) are shown. Note that the allocation image illustrated in FIG. 11 is an allocation image based on allocation information different from the allocation information explained above with reference to the drawings.

In accordance with a symbol information selection instruction from the terminal device 300, the output unit 268 allocates device information on the device 100 corresponding to selected symbol information on the allocation image in association with the symbol information and re-outputs the allocation image to the terminal device 300. For example, when the icon 400-1 is selected via an input device, such as a mouse (not illustrated) on the terminal device 300, the output unit 268 specifies the device information on the device 100 corresponding to the selected icon 400-1 from the allocation information, allocates the device information in association with the icon 400-1 on the allocation image, and re-outputs the allocation image to the terminal device 300. Accordingly, the terminal device 300 displays the allocation image on which the device information on the device 100 corresponding to the icon 400-1 is allocated in association with the icon 400-1, which enables confirmation of the device information on the device 100 corresponding to the icon 400-1.

The output unit 268 outputs an allocation image in a display mode corresponding to an instruction from the terminal device 300 to the terminal device 300. The display mode is, for example, the scaling factor or transparency of the allocation image (e.g., transparency of the allocation (allocation represented by the intermediate allocation information) excluding the device 100).

The information processing apparatus 200 may edit the allocation information in accordance with the instruction from the terminal device 300 (e.g., the allocation of the device 100 and the allocation of the object 10).

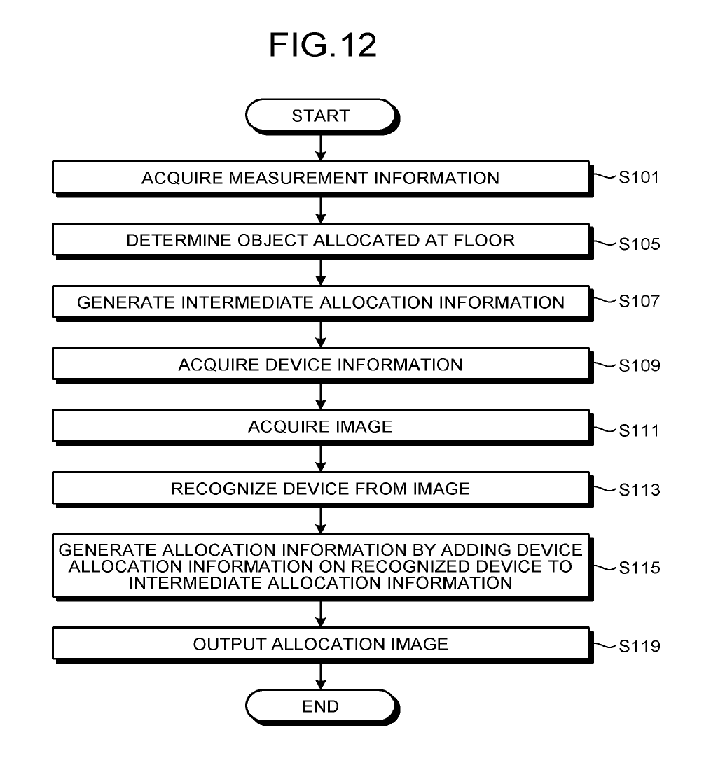

FIG. 12 is a flowchart of an exemplary process executed by the information processing apparatus 200 according to the embodiment.

First, the measurement information acquisition unit 250 acquires measurement information from the measurement device 3A (step S101).

The generation unit 252 acquires shape information from the shape information storage unit 254, collates the shape specified by the measurement information, determines which object 10 corresponds to the shape (step S105), generates intermediate allocation information (step S107), and stores the intermediate allocation information in the intermediate allocation information storage unit 256.

The device information acquisition unit 258 acquires, from each of at least one device 100, device information on the device 100 and stores the device information in the device information storage unit 260 (step S109).

The image acquisition unit 262 then acquires an image from the imaging device 3B (step S111).

The image recognition unit 264 then extracts at least one piece of code information from the image acquired by the image acquisition unit 262 and recognizes the at least one device by, on the basis of the at last one piece of code information, identifying the at last one device 100 and determining the position of the at least one device 100 (step S113).

The generation unit 252 acquires intermediate allocation information from the intermediate allocation information storage unit 256, determines the position of the at last one device 100 on the allocation represented by the intermediate allocation information on the basis of the result of the recognition of the at least one device, and generates allocation information by adding, for each device 100, position information representing the position of the device 100 on the allocation represented by the intermediate allocation information, device identifying information that identifies the device 100, and device allocation information containing symbol information corresponding to the device 100 to the intermediate allocation information (step S115).

The output unit 268 then outputs an allocation image that is based on the allocation information and that is generated by the generation unit 252 to the terminal device 300 (step S119).

As described above, according to the embodiment, because, on the basis of the measurement information on and the image of the floor 5, the allocation information that represents the allocation of the devices 100 and the objects 10 at the floor 5 and that enables identification of the devices 100 is automatically generated, it is possible to reduce the load of generating allocation information.

Furthermore, according to he embodiment, because the intermediate allocation information representing the allocation of the objects 10 at the floor 5 is generated on the basis of the measurement information on the floor 5, it is possible for the allocation information to represent the allocation of objects for which allocation is normally not represented (e.g., a trash bin, a hanger rack, and an umbrella stand that are frequently moved). This makes it possible to correctly estimating the moving path at the floor 5.

Modification 1

According to the embodiment, on the allocation image, the symbol information may be displayed in a color corresponding to the state information on the device corresponding to the symbol information. For example, the output unit 268 may display the icon 400-1 in blue when the state information in the device information on the device 100 corresponding to the icon 400-1 represents a normal state and may display the icon 400-1 in red when the state information represents a failure state.

Such display enables the user to know the state of the devices 100.

The device information acquisition unit 258 may periodically acquires device information on at least one device 100 from the at least one device and periodically generate (update) the allocation information in accordance with the acquisition of the device information. In this case, because the device information in the allocation information is kept at the latest state, it is possible to display the latest state of the devices 100 by the colors of the icons 400 on the allocation image, which enables the user to know the latest states of the devices 100.

Modification 2

According to the embodiment, the measurement device 3A may periodically perform measurement, the measurement information acquisition unit 250 may acquire measurement information each time the measurement device 3A performs measurement, i.e., periodically, the imaging device 3B periodically capture an image, and the image acquisition unit 262 acquire an image each time the imaging device 3B captures an image, i.e., periodically, and the generation unit 252 may periodically generate (update) the allocation information in association with acquisition of the measurement information and image.

This makes it possible to keep the latest allocation information and it is possible for the allocation image based on the allocation information to constantly represent the latest allocation.

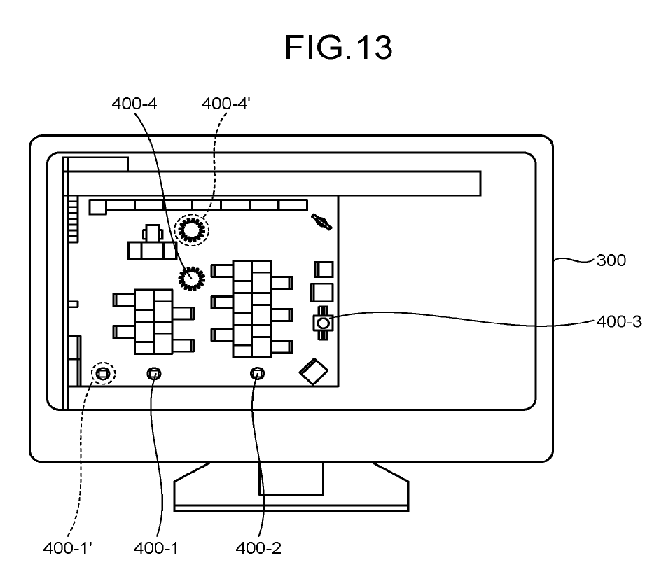

In this case, when allocation of at last one device 100 is different from that of the allocation information generated in the previous time, the output unit 268 may output an allocation image that enables knowing the previous position of the at least one device 100. In other words, when the position information on the device 100 varies due to updating of the allocation information, for example, the output unit 268 may output the allocation image illustrated in FIG. 13. According to the example illustrated in FIG. 13, because the position information on the device 100 corresponding to the icon 400-1 and the device 100 corresponding to the icon 400-4 varies from the previous one, an icon 400-1′ is allocated at the previous position of the device 100 corresponding to the icon 400-1 and an icon 400-4′ is allocated at the previous position of the device 100 corresponding to the icon 400-4.

This enables the user to know how the devices 100 were moved. In this case, the allocation information has to contain not only the latest position information on the devices 100 but also the previous position information. Furthermore, the same processing may be performed not only for the devices 100 but also for the objects 10.

Modification 3

According to the embodiment, the measurement device 3A may perform measurement for multiple times for one measurement, the measurement information acquisition unit 250 may acquire multiple pieces of measurement information each time the measurement device 3A performs measurement, and the generation unit 252 may determine whether there is a moving object at the floor 5 on the basis of the multiple pieces of measurement information and, when there is a moving object, may generate intermediate allocation information excluding the moving object. When there is a moving object at the floor 5, because the position of the moving object differs according to each piece of measurement information, it suffices if an object whose position differs according to each piece of measurement information be determined as a moving object and be removed. When the measurement device 3A performs measurement for multiple times, it is preferable that the measurement device 3A change the frequency of laser light at each measurement.

Program

A program executed by the information processing apparatus 200 according to the embodiment and the modifications is provided by storing it in a file in an installable format or an executable format in a computer-readable storage medium, such as a CD-ROM, a CD-R, a memory card, a digital versatile disk (DVD), or a flexible disk (FD).

Alternatively, the program executed by the information processing apparatus 200 according to the embodiment and the modifications may be provided by storing it in a computer connected to a network, such as the Internet, and causing it to be downloaded via the network. Alternatively, the program executed by the information processing apparatus 200 according to the embodiment and the modifications may be provided or distributed via a network, such as the Internet. Alternatively, the program executed by the information processing apparatus 200 according to the embodiment and the modifications may be provided by previously installing it in, for example, a ROM.

The program executed by the information processing apparatus according to the embodiment and the modifications is configured as a module for implementing each of the above-described units on a computer. As practical hardware, for example, the CPU loads the program from the ROM to the RAM and executes the program so that each functional unit is implemented on a computer.

Although the invention has been described with respect to specific embodiments for a complete and clear disclosure, the appended claims are not to be thus limited but are to be construed as embodying all modifications and alternative constructions that may occur to one skilled in the art that fairly fall within the basic teaching herein set forth.

What is claimed is:

1. An information processing apparatus comprising:
a measurement information acquisition unit configured to acquire measurement information obtained by measuring a space in which at least one device and at least one object are allocated;
an image acquisition unit configured to acquire an image obtained by imaging the space;
an image recognition unit configured to recognize the at least one device from the image; and
a generation unit configured to, on the basis of the measurement information and a result of the recognition of the at least one device, generate allocation information that represents allocation of the at least one device and the at least one object in the space and that enables identification of the at least one device.

2. The information processing apparatus according to claim 1, wherein the generation unit
generates intermediate allocation information representing allocation of the at least one object in the space on the basis of the measurement information,
determines a position of the at least one device on the allocation represented by the intermediate allocation information on the basis of a result of the recognition of the at least one device, and
generates the allocation information by adding, for each of the at last one device, position information representing the position of the device on the allocation represented by the intermediate allocation information, device identifying information that identifies the device, and symbol information corresponding to the device to the intermediate allocation information.

3. The information processing apparatus according to claim 2, further comprising a device information acquisition unit configured to acquire, from each of the at least one device, device information that is information on the device and that contains at last the device identifying information,
wherein, for each of the at least one device, the generation unit adds the device information as the device identifying information to the intermediate allocation information.

4. The information processing apparatus according to claim 3, wherein
the device information further contains type identifying information that identifies a type of the device, and
for each of the at least one device, the generation unit acquires symbol information corresponding to the type identifying information and adds the symbol information to the intermediate allocation information.

5. The information processing apparatus according to claim 2, wherein the generation unit acquires shape information representing a shape of each of the at least one object and generates the intermediate allocation information on the basis of the measurement information and the shape information.

6. The information processing apparatus according to claim 2, wherein
each of the at least one device is provided with code information that is obtained by coding the device identifying information on the device,
the image recognition unit extracts at last one piece of code information from the image and recognizes the at least one device by, on the basis of the at least one piece of code information, identifying the at least one device and determining the position of the at least one device on the image, and
the generation unit determines the position of the at least one device on the allocation represented by the intermediate allocation information on the basis of a result of calibration that is previously performed between a measurement device that measures the space and an imaging device that captures the image and the position of the at least one device on the image.

7. The information processing apparatus according to claim 2, wherein the generation unit generates actual distance information on an actual distance in the space on the basis of the measurement information and adds the actual distance information to the intermediate allocation information.

8. The information processing apparatus according to claim 1, further comprising an output unit configured to output an allocation image based on the allocation information.

9. The information processing apparatus according to claim 3, further comprising an output unit configured to output an allocation image based on the allocation information to an external device,
wherein, in the allocation image, on a position of each of the at least one device on the allocation represented by the intermediate allocation information, symbol information corresponding to the device is allocated, and
in accordance with an instruction for selecting the symbol information from the external device, the output unit allocates the device information on the device corresponding to the symbol information in association with the selected symbol information on the allocation image and re-outputs the allocation image to the eternal device.

10. The information processing apparatus according to claim 9, wherein
the device information further contains state information representing a state of the device, and
in the allocation image, the symbol information is displayed in a color corresponding to the state information on the device corresponding to the symbol information.

11. The information processing apparatus according to claim 10, wherein
the device information acquisition unit periodically acquires the device information from each of the at least one device, and
the generation unit periodically generates the allocation information.

12. The information processing apparatus according to claim 8, wherein
the measurement information acquisition unit periodically acquires the measurement information,
the image acquisition unit periodically acquires the image;
the generation unit periodically generates the allocation information, and
when an allocation of the at least one device is different from that of the allocation information generated in the previous time, the output unit outputs an allocation image that enables knowing the previous position of the at least one device.

13. The information processing apparatus according to claim 1, wherein
the measurement information acquisition unit acquires the measurement information for multiple times, and
on the basis of the multiple pieces of measurement information, the generation unit determines whether there is a moving object in the space and, when there is the moving object, generates the intermediate allocation information excluding the moving object.

14. An information processing system comprising:
a measurement unit configured to acquire measurement information obtained by measuring a space in which at least one device and at least one object are allocated;
an imaging unit configured to capture an image of the space;
an image recognition unit configured to recognize the at least one device from the image; and
a generation unit configured to, on the basis of the measurement information and a result of the recognition of the at least one device, generate allocation information that represents allocation of the at least one device and the at least one object in the space and that enables identification of the at least one device.

15. An allocation information generation method comprising:
acquiring measurement information obtained by measuring a space in which at least one device and at least one object are allocated;
acquiring an image obtained by imaging the space;
recognizing the at least one device from the image; and
generating, on the basis of the measurement information and a result of recognition of the at least one device, allocation information that represents allocation of the at least one device and the at least one object in the space and that enables identification of the at least one device.
